(19) United States
(12) Patent Application Publication
(10) Pub. No.: US 2013/0035948 A1
(43) Pub. Date: Feb. 7, 2013

(54) Discharge summary method and apparatus for a physichart system

(71) Applicant: David Babalola Olalekan, Nashville, TN (US)

(72) Inventor: David Babalola Olalekan, Nashville, TN (US)

(21) Appl. No.: 13/507,276

(22) Filed: Jun. 18, 2012

Related U.S. Application Data
(60) Provisional application No. 61/520,838, filed on Jun. 16, 2011.

(51) Int. Cl. G06Q 50/22

(52) U.S. Cl. 705/2

(57) ABSTRACT

A diagnostic medical system management tool that emphasizes local data collection in a global clinical environment to create a cohesive network of computer systems. This invention automates the necessary relationship between caregivers and digital knowledge resources through a functional diagnostic interface.

This application claims the benefit of provisional application 61/520,838 filed Jun. 16, 2011.

### TECHNICAL FIELD

The present invention generally relates to computer based systems and methods that facilitate patient diagnosis and treatment in a healthcare environment.

### BACKGROUND

Upon discharge from a medical facility a patient who has undergone a variety of tests, treatments and services from a network of many caregivers will have a complex billing. Before that billing is presented, many steps must occur to make sure the billing accurately reflects the cost to the facility and the price to be paid by the patient. Financial accounting steps are but one part of discharge. The medical treatment must be summarized to make sure the patient knows what has occurred and what treatment needs to occur after discharge. There may be only one doctor on duty at the time of discharge and that doctor may be called upon to summarize the work of many other caregivers on many days of a patient's stay. The problems this presents include accuracy, thoroughness and can cause harm to the patient.

It would be desirable to have a computer system of medical treatment that considered these and other pertinent factors as it generated a medical discharge summary.

### SUMMARY

The following presents a simplified summary of the specification in order to provide a basic understanding of some aspects of the specification, not an extensive overview of the specification. It is intended to neither identify key or critical elements of the specification nor delineate any scope particular embodiments of the specification, or any scope of the claims. Its sole purpose is to present some concepts of the specification in a simplified form as a prelude to the more detailed description that is presented later.

A method and apparatus are presented herein that can be subcomponents of a Physichart system. As used in this specification, Physichart is an electronic medical records management system. In an embodiment a medical discharge component accesses a server database of medical data, reads a preliminary diagnosis, and reads information from a client vital signs component. The medical discharge component searches business rules interpreted from medical data such as Current Procedural Terminology (CPT) and Food and Drug Administration (FDA) approved medications. The medical discharge component uses the preliminary diagnosis provided by a client and the server vital signs, component data, to generate steps that can become medical orders for treating each patient. These steps include both the best standard of care and case-specific alternatives. The medical discharge component saves the data from all client transactions to the client computer memory.

In an embodiment, the discharge summary method is part of a system of methods including a client patient management component. The client patient management component presents the output from the discharge summary component to a caregiver and to a network of caregivers. The client patient management component inserts results into electronic records of patient care notes and saves the data from all client transactions to the client computer memory.

In an embodiment, the discharge summary method communicates between the components residing in memory at a medical data source, a medical data manager, a server, a client and peripherals is facilitated using internet protocols or hardwiring, and is configured to accommodate existing communication technologies.

In an embodiment, the discharge summary is initiated with one mouse, pointer click by a user. This includes a touch to a touchscreen.

In an embodiment a discharge summary method reads the security information entered by caregivers. This security information includes the patient's wishes for release and disclosure of the patient's private information. The discharge summary method reads this information and defines business rules for the scope and limits of disclosure by the client facility. These business rules regulate the system of components regarding any transactions or information that are read from the patient, saved to memory, and communicated among any of the computer components. Information is communicated only when allowed by the patient through release forms according to applicable rules, laws and regulations.

In an embodiment, the discharge summary component is further used to update business rules and medical data on a regular frequency and as needed. The data for these updates can be provided by human managers who research medical data sources.

### BRIEF DESCRIPTION OF THE DRAWINGS

FIG. 1 is an illustration of a patient vital signs component flow diagram of an exemplary method, 100, that can be performed by a computer.

FIG. 2 is an illustration of the computers, 200, in an exemplary Physichart system.

FIG. 3 is an illustration of server component blocks and connections, 300, of an exemplary Physichart system.

FIG. 4 is an illustration of component blocks and connections of medical data sources, 400, in an exemplary Physichart system.

FIG. 5 is an illustration of the computers, 500, in an exemplary Physichart system.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding of this innovation. It may be evident, however, that the innovation can be practiced without these specific details. In other instances, well-known structures and devices are shown in block diagram form in order to facilitate describing the innovation.

The subject disclosure presents one, or a set of software components operating in server and client computer systems. In an embodiment, these components read a preliminary diagnosis from another component along with other patient data, intake medical opinions, intake medical observations, intake medical data from medical sources, intake client facility information, and use that information to create patient management instructions, present those results for the user and make information available for storage regarding each use of the system as a transaction.

As used in this specification, a client computer system can be owned and operated by a hospital, a school, a laboratory, a library, a government institution, a standards institution, a solo medical practice, a group medical practice, an outpatient clinic, a pharmacy, an individual such as a student or researcher, a political organization, a news reporting organization, clinical research operation, salesperson or other person interested in the Physichart system.

In an embodiment, communication among the server and clients can be facilitated using the internet. HTTP and secure HTTPS protocols can be used to provide communications from Physichart systems to allow access to client system memory. FTP protocols can be used to provide communications from the client system to limit access to Physichart memory. Access by other protocols and other means are comprehended to facilitate communications such as hardwiring any combination of the sources, manager systems, server, client and peripherals.

As used in this specification, patient data can be read from a variety of sources. This includes recording vital signs. This includes the patient giving information through computerized interviews. This includes diagnostic measurements taken by healthcare providers such as nurses, technicians, laboratories, and doctors. Such diagnostic measurements include those made using tools such as blood pressure cuffs, thermometers, and other traditional means whose results are read and recorded by hand. Recording includes writing or entering to a computer. Such diagnostic measure measurements also includes those made using systems that automatically enter results to a computer such as digital x-ray machines, electronic blood glucometers, and cardiac stress test systems.

Patient information can include vital signs such as blood pressure (BP), respiratory, pulse, temperature, height, weight, oxygen saturation, and pain scale and derived values such as body mass index (BMI) and body surface area. Each of these examples of derived results also demonstrate transient, changing values and would be calculated using most current available data. Patient data includes Tmin (minimum recorded body temperature), Tmax (maximum recorded temperature), BPmin (minimum BP), BPmax (maximum BP) for both, diastolic and systolic blood pressures, and time of measurements taken, within a programmable range of time.

As used in this specification, patient data can also include patient histories from a variety of sources. This includes documents scanned into the system or otherwise entered by users. Once entered, patient data can be retained in the Physichart system indefinitely and transferred. Transfer can be made using regulatory compliant methods housed within the components, such as digitized release forms that are signed and scanned as part of a patient's profile.

Patient data can include patient limitations such as other medical conditions, psychological conditions, allergy history, health habits, personality, risk aversion and financial ability to afford the best procedures.

As used in this specification, medical opinions and observations can include those of the doctors immediately providing treatment and those who provided prior treatment. Medical opinions and observations can also include those made by others. Medical opinions and observations can include other professionals who can contemporaneously review patient diagnostic details remotely using the Physichart system. Medical opinions and observations can also include contemporaneous notes made during treatment, Medical opinions and observations can include historic opinions given about similar patient data, such as prior patient treatment notes, those found in the footnotes of standard medical resources like the Physician's Desk Reference. Medical opinions and observations can be in a variety of forms including free-text notes written by hand, recorded voice notes, scanned documents and those typed directly into the computer systems.

As used in this specification, medical sources can include drug data, procedures data, disease classification data, clinical guidelines data, and government regulations data. In an embodiment, this invention uses the published data of approved medications, medical treatments and procedures, clinical specialty guidelines and prevailing government laws. Medical sources are generally limited to those professionally respected and ethically accepted; however any source can be included. Methods within the system can be used to identify the level of confidence that should be afforded to a source. In an embodiment these data sources are monitored and introduced to the server computer system by human medical data managers.

As used in this specification, a caregiver includes but is not limited to a doctor, nurse, nurse practitioner, physician assistant, technician, friend, family member, emergency responder, or intermeddler providing a medical action to a person.

As used in this specification, client facility information includes the limitations of the environment such as drug formulary, procedures offered, capacity, historic patient census, equipment available, access to other facilities, transportation considerations, weather, employee trends, employee scheduling, and real time status of external resources.

As used in this specification, patient management instructions can include drug, physical intervention, psychological intervention, counseling instructions, spiritual actions, social actions, chronological considerations, immediate actions, short term care, long term care, and automatic notice to other resources.

In an embodiment, a transaction is defined as each use of the system to diagnose a patient, research any topic, enter medical data, or otherwise utilize the component programs of Physichart. Transactions are stored in memory at the client computer system to provide immediately relevant information and as an archive. Transactions are also stored at the server computer system to provide a comprehensive archive of all Physichart clients.

As used in this specification, information about the transactions can include the patient identity, patient history of conditions, patient history of treatment, patient allergies, patient responses to treatments, patient financial information, patient insurance information, and other patient specific information. Information about the transactions can include the medical diagnosis, the medical information relied upon, the patient information relied upon, the preferred treatment, the actual treatment, the users who provided information during the transaction, and other treatment specific information. Information about the transactions can include times, dates, costs, payments, employees who were involved as caregivers, places where care was provided, facility status information (such as temperatures, humidity, outside weather and utility conditions) and other information specific to the facility providing care.

As used in this specification, reporting and study through other client services components can include the following. Reporting and study can include treatment of patients. Reporting can include financial reports, medical reports, inventory reports, staffing reports, facility operations reports, diagnostic trend reports, statistical reports, quality reports, governmental required reporting, and other reports that utilize the information stored by the Physichart system. Studies can include those by students, institutions, healthcare providers, legislators, salespersons, marketing persons, clinical researchers, and others interested in investigating a particular topic.

The component that is the subject of this specification is a client component that resides in the client computer system. The Physichart system cam also contain client services components resident in the client computer system that interface with the server and client patient management components. Client services components can include a discharge summary component, a scheduler component, a clinical images manager component, a coding and billing component, a facility and caregiver manager resource data component, an education and statistics component, a document manager component, a communicator component, and other optional components that would utilize the information provided to improve the healthcare system.

In an embodiment, where there are patient and facility limitations the system can provide both the best standard of care and case-specific alternatives for the particular patient, facility, and the disease or diagnosis.

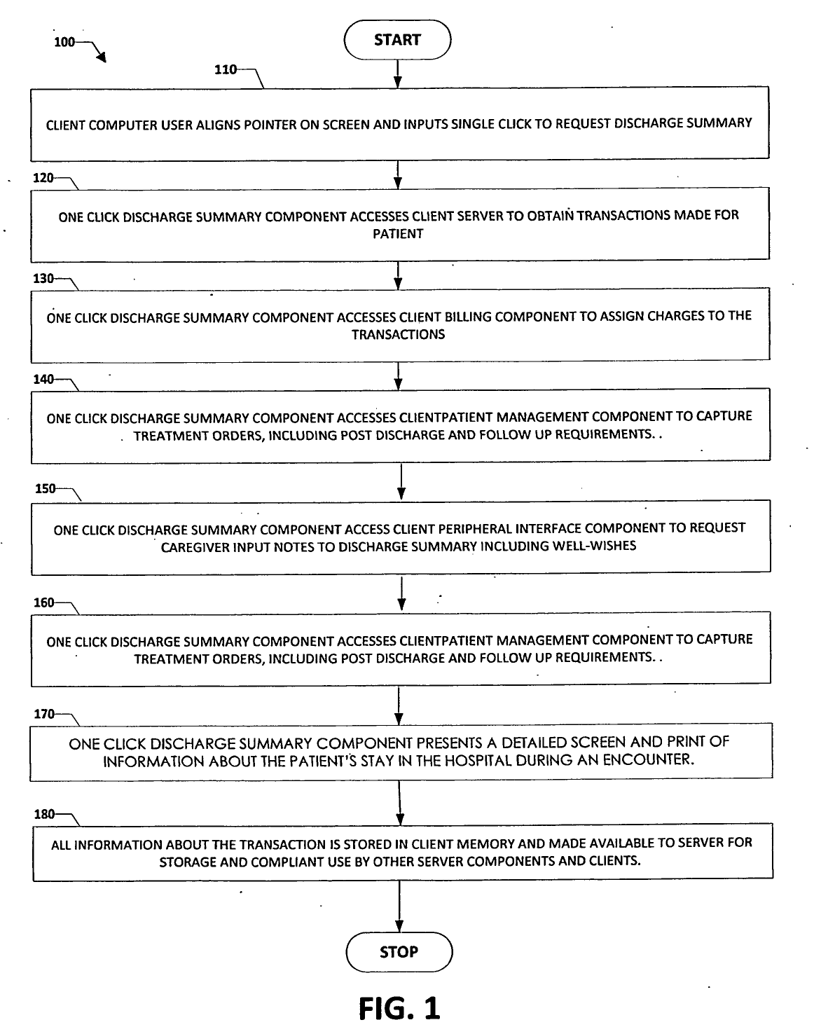

FIG. 1 is an illustration of a discharge summary flow diagram of an exemplary method, 100, that can be performed by a computer. At 110, the client computer user aligns pointer on screen and inputs single click to request discharge summary.

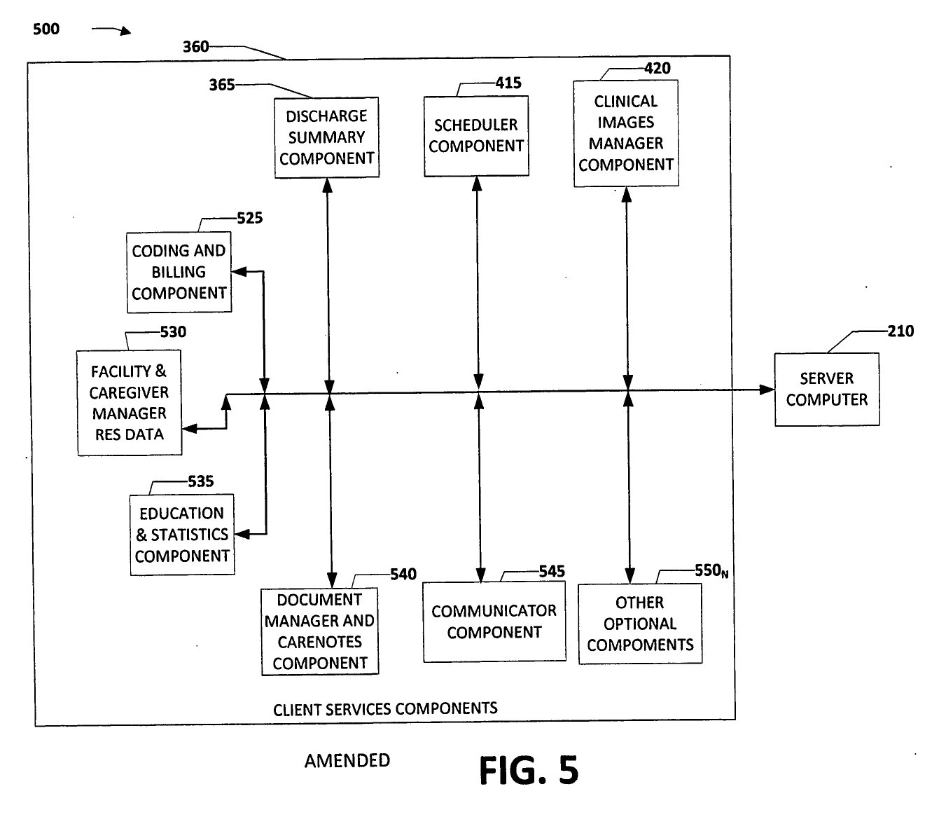

In an embodiment the discharge summary component can display information graphically and numerically. These are programmable options. Information can also be communicated through any of the peripheral devices shown in FIG. 5.

At 120, the one click discharge summary component accesses client server to obtain transactions made for patient. At 130, the one click discharge summary component accesses client billing component to assign charges to the transactions. Other charges may be indicated by the client billing component and can be included in the discharge summary.

At 140, the one click discharge summary component accesses client patient management component to capture treatment orders, including post discharge and follow up requirements.

At 150, the one click discharge summary componentaccesses client peripheral interface component to request caregiver input notes to discharge summary. This can include personal comments and encouragement.

At 160, the one click discharge summary component accesses client patient management component to capture treatment orders, including post discharge and follow up requirements.

At 170, the one click discharge summary component presents a detailed screen and optional print of information about the patient's stay in the hospital.

At 180, all information about the discharge summary transaction is stored in client memory and made available to server for storage and compliant use by other server components and clients.

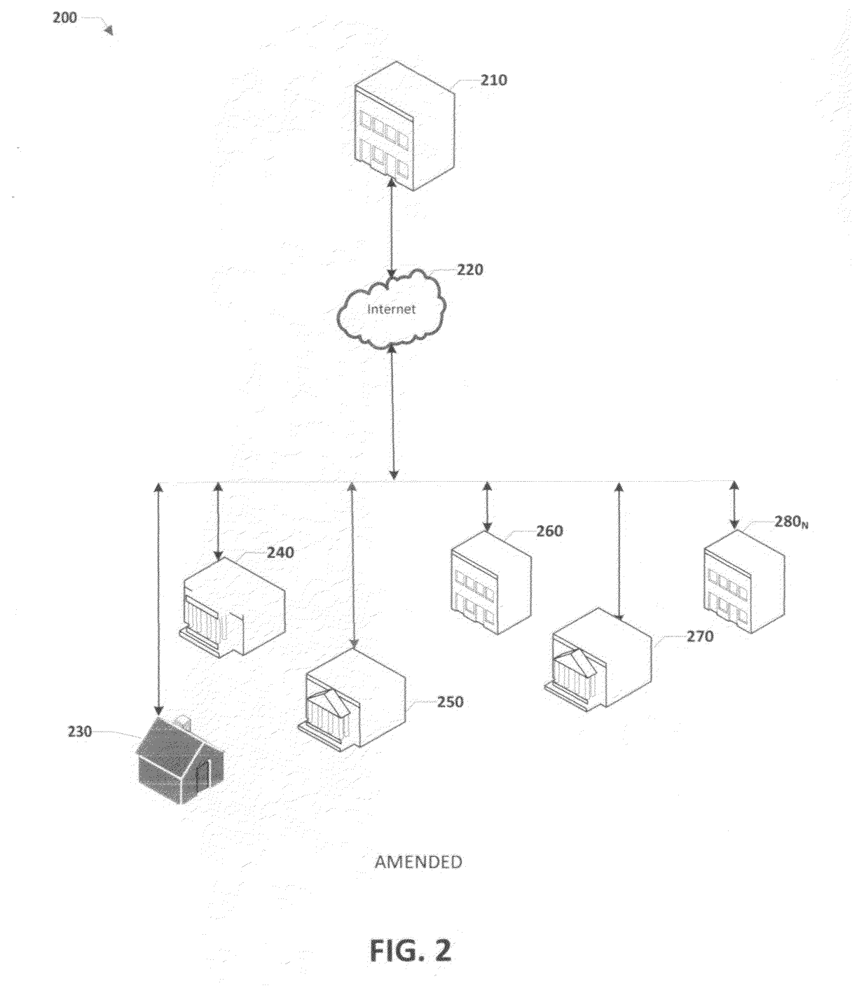

FIG. 2 is an illustration of the facilities and organizations, 200, in an exemplary Physichart system. The Physichart facility is shown as 210. An example of communication with Physichart is shown as interactions on the internet, 220. Communications with the client systems are also shown as interactions with the internet, 220. A solo practice client is shown as 230. An outpatient clinic client is shown as 240. A hospital is shown as 250. A medical practice group is shown as 260. A university system is shown as 270. And multiple other users are shown as 280_{N}, where N is intended to show a finite number of existing possibilities exemplified in this specification.

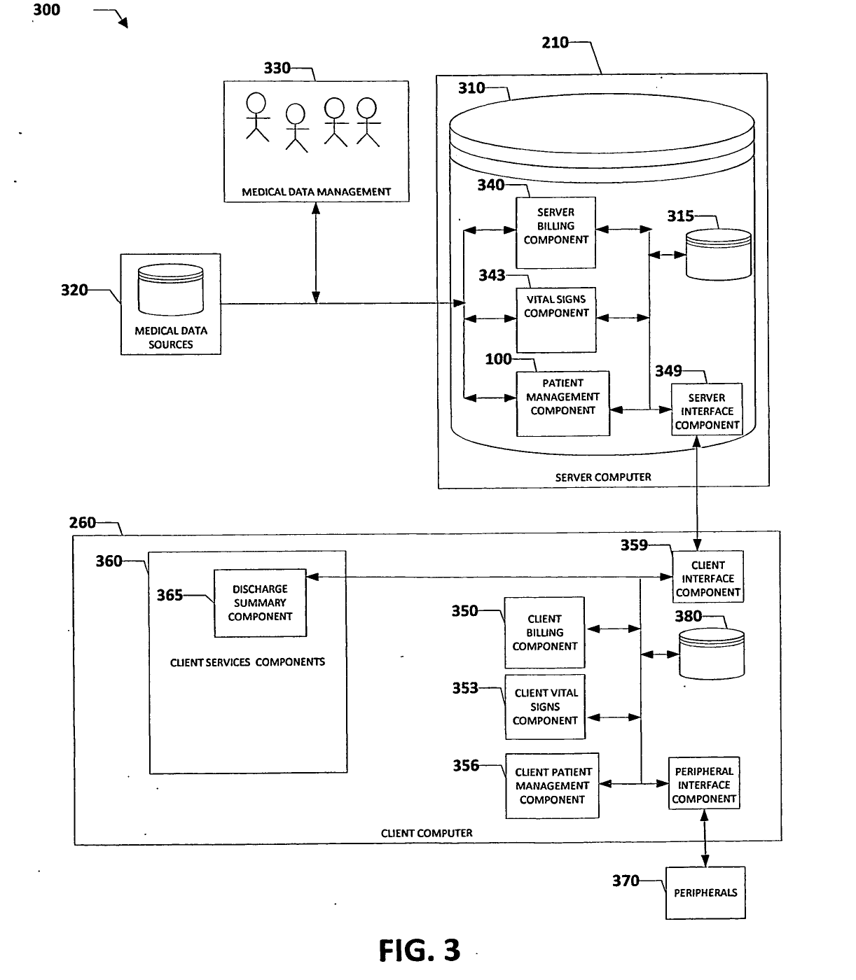

FIG. 3 is an illustration of server component blocks and connections, 300, of an exemplary Physichart system. A Physichart server system 210 is communicatively coupled to a client system, 260, as shown in FIG. 1 and FIG. 2. The Physichart server system is shown to include server memory, 310. Server memory contains storage and the operational software components. Storage, 315, represents servers within the system of server memory or partitions of memory within a particular storage medium. The transaction history is stored here. Functional copies of the medical data are stored here. Medical data sources, 320, are shown coupled to the server computer and to medical data management, 330. Medical data management is a group of human users with access to the server computer and medical data sources. Medical data managers serve to filter information received from the medical data sources.

The Billing component, 340, resides in the server computer memory. The server billing component reads transaction data stored at 315 to prepare standard reports for the client computer system. The server billing component also prepares standard reports of the transactions for the entire network of clients.

The server vital signs component, 343, resides in the server computer memory, 310. The server vital signs component reads transaction data stored at 315 to prepare a profile for the client vital signs component, 353. The server vital signs component is included in a separate application as a discrete invention.

The server patient management component, 343, resides in the server computer memory, 310. The server patient management component reads transaction data stored at 315 to prepare a profile for the client vital signs component, 353. The server patient management component is included in a separate application as a discrete invention.

The server interface component, 349, manages and facilitates communication between the medical data managers, 330, the client computer systems, 260; and the server computer, 210. The server interface component facilitates communication by reading the output from each of the server and client Physichart component programs and providing input to each of the server and client Physichart component programs. The server interface component is also coupled to the server memory, 315, and is used to create archives by saving and retrieving data. The use of a single server interface component allows Physichart to manage the transactions that occur. It is an important aspect of this invention that it maintains a comprehensive record of transactions. It is this comprehensive record that allows Physichart to improve healthcare on a global basis, for example, as they research, generate reports, prepare more complete medical histories for patients, instantly print a discharge summary, and schedule resources.

The client billing component, 350, resides in the client computer memory. The client billing component reads transaction data stored at 380 and at the server to prepare standard reports for the client computer system.

The client vital signs component, 353, resides in the client computer memory, 310. The client vital signs component operates according to a profile established and stored at the server client vital signs component, 343. The vital signs component is included in a separate application as a discrete invention.

The client patient management component, 353, resides in the client computer memory. The client patient management component reads transaction data stored at the server memory, 315 and client memory, 380 and operates according to a profile established and stored at the server vital signs component, 353. The client patient management component is included in a separate application as a discrete invention.

A client interface component, 359, functions similar to the server interface component, 349, and is resident on the client computer system, 260. The client interface component, 349, manages and facilitates communication between the client computer systems, 260; and the server computer, 210. The server interface component facilitates communication by reading output, and providing input to the server interface component, and the client Physichart component programs. The client interface component is also coupled to the client memory, 380, and is used to create archives by saving and retrieving data. The use of a single client interface component allows Physichart to manage the transactions that occur. It is an important aspect of this invention that it maintains a comprehensive record of client transactions just as the server maintains a comprehensive record for all clients. It is this comprehensive record that allows the end user to improve healthcare local to the client, for example, as they research, generate reports, prepare more complete medical histories for patients, instantly print a discharge summary, and schedule resources.

In an embodiment, a peripheral interface component is resident in a client computer, 260 and is used to send and receive information between peripherals, 370, and client communication components 350, 353, 356, 360 and 380. Peripherals 370 can include any of the items shown in FIG. 2 as the portable tablet computer, 260; the desktop PC, 262; the smart phone or personal digital assistant, 264; the laptop, 266; the dumb terminal, 268; and multiple other peripheral access devices are shown as 270_{N}, where N is intended to show a finite number of existing possibilities exemplified in this specification.

In an embodiment, client services components, 360, are resident in the client computer memory. The client services components are a series of programs that are discussed in this specification. The client services components read user input, transaction data stored at 380, transaction data stored at the server memory, 315; and processes the information to output combinations of information. These combinations of information are generally useful to improve healthcare by improving communications and making more information available to healthcare providers and researchers.

Client services components can read user input through peripherals, 370. Each client services component is programmed to the provide categories of output. The components can be separated for marketing purposes and for management control.

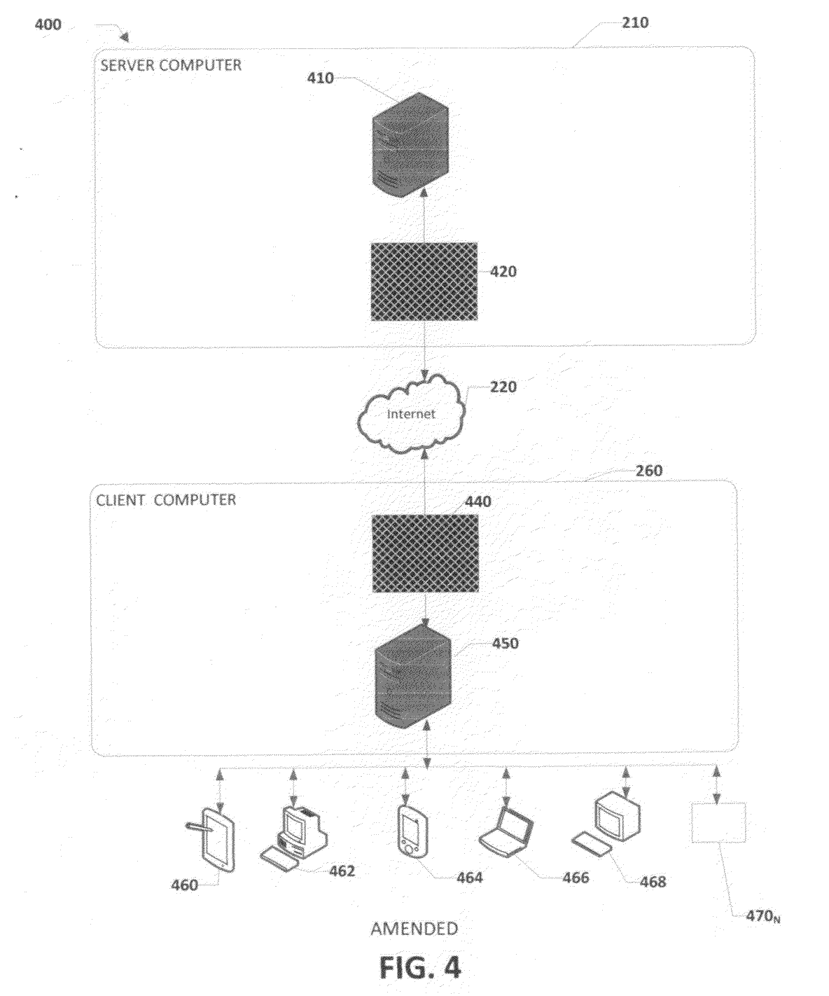

FIG. 4 is an illustration of the computers, 400, in an exemplary Physichart system. The server computer system, 210, and the client computer system 260 are shown connected through the internet, 220. The Physichart computer system, 410 is shown as a single unit however one of ordinary skill in the computer arts would understand that a system of server computers could be used to allow Physichart to operate at a much larger scale. Similarly, the client computer, 450 is shown as a single unit that exemplifies many possible computers used by the client computer system, 260. Likewise, the portable tablet computer, 460; the desktop PC, 462; the smart phone or personal digital assistant, 464; the laptop, 466; the dumb terminal, 468 are shown as individual items but one of ordinary skill in the art of computing would understand that a system of these peripheral access items could include multiple items. Also, multiple other peripheral access devices are shown as 470_{N}, where N is intended to show a finite number of existing possibilities exemplified in this specification.

The aforementioned FIG. 4 items can be communicatively coupled using interactions on the internet, 220. Examples of client facilities include a solo practice, an outpatient clinic, a hospital, a medical practice group, a university system, and multiple other users including a finite number of existing possibilities exemplified in this specification.

FIG. 5 is an illustration of client services components as blocks and connections, 500, in an exemplary Physichart system. Client services components, 360, are also shown collectively in FIG. 3.

Client services components can include a discharge summary component, 510. In an embodiment, this component greatly assists the caregivers and can provide discharge summaries for patients who have been admitted to a hospital, and are about to be discharged. When a patient is about to be discharged, a healthcare provider can make just one button click, this initiates the Physichart client and server systems to provide information about the patient's stay in the hospital including all transactions. The information can include all of the general elements of a discharge summary, including the admitting diagnosis, the current medications, home medications, discharge medications, and the new diagnosis, the detailed findings on admission, the initial lab findings and the all-important hospital course.
8. In an embodiment, the discharge summary component can include a discharge medication component whereby a discharge medication component transfers medication data from a Physichart server computer memory. The discharge medication component includes past prescription transaction history. The discharge medication component includes current prescription transaction history. The discharge medication component includes post-discharge prescription recommendations. The discharge medication component reviews prescription conflicts. The discharge medication component provides results for caregiver review and solicits approval. The discharge medication component saves discharge medication component to client memory. And the discharge medication component presents results as output to the discharge summary component.

Recurrent tests (e.g. vital signs, x-rays, basic labs) can be scanned for relevance and where possible, presented as a graph. A discharge summary can also include discharge medications. This system allows the user to transfer medication both from in-hospital stay and home medication. It also enables the caregiver to have a final review of all the data that has been generated by the system before a final signature is appended by the user. Caregiver can adjust discharge medications through a drag-and-drop method. Same goes for discharge diagnoses.

At the end of the process executed in the discharge summary component, there is a “Summary of Summaries” which the user reads, and certifies before saving in to permanent records. This component is absolutely unique in that the system actually generates this discharge summary and monitors the patient as they go from floor-to-floor, from one section of hospital to another. The system generates the detailed hospital course and this can be retrieved easily when the discharge summary is activated.

Client services components can include a scheduler component, 515. This component enables the patient, user, caregiver, or their representative to schedule appointments for patients. Each appointment can be programmable in time increments such as 15 to 120 minutes. All interested caregivers and approved parties receive appropriate messages for each new and modified/canceled appointment; and a patient can receive interval reminders. This component can allow for multi-use.

For example, in a hospital with multiple caregivers (doctors or PAs) this scheduler component allows the user to see at a glance all the pending and future appointments. The patient is also able to schedule their own appointments from home, they can search for the earliest appointment with any particular doctor in any particular group and schedule their own appointment. Once it is done, a notification is sent both to the affected caregivers and the patient as well and reminders are sent at intervals to remind them. Should there be any change, for instance if the caregiver is not going to be available on the date.

A change made by the caregiver in the system can be automatically communicated with all affected parties. This also applies to the patient, if they want to cancel their appointment they can go online and when they cancel the appointment it will notify the doctor and any other interested party automatically. They do not need to call or contact anybody else once they go online. A doctor can block out days or times and it's such that when a patient schedules an appointment, it's automatically is blocked so that another person cannot schedule the same time as appointment for that caregiver.

With the ability to search for the earliest appointment or for a particular time of day or week or month, each patient is able to get the best care they can at the time most convenient to them.

Client services components can include a clinical images manager component, 520. In an embodiment, this component manages images in the client Physichart system. Images managed can include for example, EKGs, Xrays, pictures of lesions, digital images taken by healthcare providers, and single images from CT, ultrasound scans, MRI, and PET scans. There is provision for zooming, rotating/flipping loading, and saving the images. A user can describe each or group of images, and offer possible diagnoses. Images can be arranged by date, encounter, type or by diagnoses. This component also helps with the educational aspect for the caregivers in-training—it enables them to learn from the images without revealing the identifying information of the patients (in compliance with HIPPA).

Client services components can include a coding and billing component, 525. In an embodiment, the coding and billing component allows a healthcare provider to charge patients for health care services and products that they have received. This component is deeply integrated with all other Physichart components. The basic function of a coding and billing component is to enable the user to charge the patient for the services that they receive and to submit the charges electronically to the payment clearing house where the payments are processed. If the payments are rejected for any reason the system automatically reviews and resubmits such applications again and again until a final decision is made on a particular bill. This component allows the administrator or the user of the software to view the patient's charges and to follow up on their payments and to also notify the users at intervals as to who is still owing and who is not.

Client services components can include a facility and caregiver manager res (resource) component, 530. In an embodiment, the facility and caregiver manager res component helps the administration to manage the healthcare facility and the personnel to administer care. This component can make predictions about hiring needs for particular times of the year, based on previous data. Each healthcare facility can be represented digitally, with each room, office and ER room identified in three states: Vacant, Occupied and Out of Service. The characteristics of each room, including the tools available, are also highlighted by the component. The personnel component works closely with the scheduler, 515, and communicator, 545, components for scheduling and notification purposes.

Client services components can include an educational and statistics component, 535. In an embodiment, an educational and statistics component helps the administration to manage the healthcare facility and the personnel to administer care. This component enables the users to use Physichart as an educational and statistics tool. This is the component in Physichart that deals with statistical information as well as the educational aspect in which users can learn and do simple searches and obtain data relating to particular cases rather than particular patients, so they can know how particular cases are treated and what the usual evaluations to be done on them, the findings, they can review any of the images and lab findings and progress of management.

For educational purposes, data is indexed and searchable topically, with personally identifying information hidden, so that the user can retrieve data based on a particular diagnosis irrespective of the patients affected. The statistical component assists the caregiver to know large volumes of information about their patients and the condition that they are treating. Information can include the frequency and distribution of particular illnesses, based on race, age, gender, and socioeconomic status, and it can also alert them to the occurrence of epidemics, because when a particular event or disease occurs in a particular locality with significantly increased frequency, the caregiver is able to notice that, and to inform the appropriate authorities for a particular action.

Client services components can include a document manager and carenotes component, 540. In an embodiment, this component enables the user to add both formatted text and images to the medical records. There are note templates that are provided, and user can create their own templates, either from the available templates, or de novo. Possible template categories available are History & Physical, Daily Notes, Procedure Notes, Consults, and Referrals. Under each category, there are brief, full and modified templates. A user can include images in each. Appropriate line images for male and females are provided, to highlight specific body parts. There is also a full body line drawing provided for both male and female.

Any approved user can browse the available images, select the desired one, highlight a specific portion of the image, and then drag the modified image onto the note. Alternatively, the user can use an outside picture (e.g. a freshly taken picture of the patient to illustrate a lesion). All pictures are embedded in the respective notes and form part of the medical record. Patients can enter their own data, for instance home blood pressure monitoring, blood glucose monitoring, seizure calendar, and some pictures (e.g. if they have some rash on their skin and they need the doctors to have a look at it, they can take a picture of it and directly insert it into their own medical records over the web. Also, they can bring such pictures along with them to their doctors office in a flash drive and they can be added to their medical records.

Client services components can include a care communicator component, 545. In an embodiment this is a general communication component of Physichart, sending messages by SMS, email, pager, phone and through peripherals, 370. This component can send messages either automatically or by request of the user. The message formats sent can include any available technology such as emails, SMS, MMS, personal pagers, overhead system pagers and phone. Triggers to send messages can include examples such as critical lab values, reminders for appointments, reminders for health maintenance issues, birthdays.

Examples of Physichart communicator events include the following. When Physichart receives an abnormal data, the system checks to see which caregiver is responsible for the patient at the time of the report, and notifies them. If no caregiver is recognized, the admitting caregiver is notified or at the last, the ER physician is informed. Both the patient and the caregiver receive messages regarding each new or modified appointment. Each party can search, modify or cancel an appointment before it occurs. Patient receives interval messages regarding upcoming appointments. Unless otherwise programmed, Physichart sends birthday messages to all patients and personnel. The patient receives messages regarding due health maintenance evaluations (e.g. colon screen, vaccinations, mammography, pap smear, etc).

Another embodiment of the communicator component can enable the user to send e-mails, pages, text messages, and foster communication between the patient, caregiver, and all other interested parties who are registered within the system. This component can operate in automatic mode as well as trigger mode.

Automatic modes include the entry of critical values into the system. When the lab technician inserts data into the system and it happens to be of critical value, the system confirms immediately with the person entering the data that it is indeed not a mistake. If is confirmed that it is an accurate value, it will then ask the user if the appropriate doctor should be notified. If given an answer in the affirmative, the system sends a page/text to notify both the doctor on duty as well as the doctor who requested the test depending on the setting on the system. If it's set to contact the doctor on duty only, it will do that. It notifies them that a critical entry has been entered in the system for a particular patient, however HIPPA is strictly observed such that the patient's identifying information is not revealed.

This system monitors itself over time such that if a response has not been received by the system in 60 minutes after the initial notification it sends out another message, and continues to do so at 60 minute intervals until there is a response from the doctor concerned.

This component can send appointment reminders to all the parties involved (New appointments as well as reviewed appointments). Notifications are sent to all interested parties and reminders are sent to the patients at weekly intervals and 3 days before the appropriate appointment. In some cases, it also sends recurrent notifications as well, such as birthdays of patients. The system automatically sends birthday greetings to the patients through e-mails or text messages. It also sends notifications for health maintenance visits, including annual examination, vaccinations, etc. All these are automated.

Messages can also be triggered in the component when a particular message or event in the system has been programmed by a user of the communicator component to send a message to the other users.

Other optional components, 550N, are referenced because a platform of software components is possible. This refers collectively to any program function referred within this specification and those contemplated by the inventors. The Physichart system disclosed herein is designed to accommodate such optional components.

One of ordinary skill in the art can appreciate that the various embodiments described herein can be implemented in connection with any computer or other client or server device, which can be deployed as part of a computer network or in a distributed computing environment, and can be connected to any kind of data store where media may be found. In this regard, the various embodiments described herein can be implemented in any computer system or environment having any number of memory or storage units, and any number of applications and processes occurring across any number of storage units. This includes, but is not limited to, an environment with server computers and client computers deployed in a network environment or a distributed computing environment, having remote or local storage.

Distributed computing provides sharing of computer resources and services by communicative exchange among computing devices and systems. These resources and services include the exchange of information, cache storage and disk storage for objects, such as files. These resources and services also include the sharing of processing power across multiple processing units for load balancing, expansion of resources, specialization of processing, and the like. Distributed computing takes advantage of network connectivity, allowing clients to leverage their collective power to benefit the entire enterprise. In this regard, a variety of devices may have applications, objects or resources that may participate in the smooth streaming mechanisms as described for various embodiments of this disclosure.

As mentioned above, while exemplary embodiments have been described in connection with various computing devices and network architectures, the underlying concepts may be applied to any network system and any computing device or system in which it is desirable to publish or consume media in a flexible way.

The word “exemplary” is used herein to mean serving as an example, instance, or illustration. For the avoidance of doubt, this matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, for the avoidance of doubt, such terms are intended to be inclusive in a manner similar to the term “comprising” as an open transition word without precluding any additional or other elements.

Computing devices typically include a variety of media, which can include computer-readable storage media. Computer-readable storage media can be any available storage media that can be accessed by the computer, is typically of a non-transitory nature, and can include both volatile and nonvolatile media, removable and non-removable media. By way of example, and not limitation, computer-readable storage media can be implemented in connection with any method or technology for storage of information such as computer-readable instructions, program modules, structured data, or unstructured data. Computer-readable storage media can include, but are not limited to, RAM, ROM, EEPROM, flash memory or other memory technology, CDROM, digital versatile disk (DVD) or other optical disk storage, magnetic cassettes, magnetic tape, magnetic disk storage or other magnetic storage devices, or other tangible and/or non-transitory media which can be used to store desired information. Computer-readable storage media can be accessed by one or more local or remote computing devices, e.g., via access requests, queries or other data retrieval protocols, for a variety of operations with respect to the information stored by the medium.

As mentioned, the various techniques described herein may be implemented in connection with hardware or software or, where appropriate, with a combination of both. As used herein, the terms “component,” “system” and the like are likewise intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers. Further, a “device” can come in the form of specially designed hardware; generalized hardware made specialized by the execution of software thereon that enables the hardware to perform specific function (e.g., coding and/or decoding); software stored on a computer readable medium; or a combination thereof.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it is to be noted that one or more components may be combined into a single component providing aggregate functionality or divided into several separate sub-components, and that any one or more middle layers, such as a management layer, may be provided to communicatively couple to such sub-components in order to provide integrated functionality. Any components described herein may also interact with one or more other components not specifically described herein but generally known by those of skill in the art.

In view of the exemplary systems described above, methodologies that may be implemented in accordance with the described subject matter will be better appreciated with reference to the flowcharts of the various figures. while for purposes of simplicity of explanation, the methodologies are shown and described as a series of blocks, the claimed subject matter is not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, may be implemented which achieve the same or a similar result. Moreover, not all illustrated blocks may be required to implement the methodologies described hereinafter.

In addition to the various embodiments described herein, it is to be understood that other similar embodiments can be used or modifications and additions can be made to the described embodiment(s) for performing the same or equivalent function of the corresponding embodiment(s) without deviating there from. Still further, multiple processing chips or multiple devices can share the performance of one or more functions described herein, and similarly, storage can be affected across a plurality of devices. Accordingly, the invention is not to be limited to any single embodiment, but rather can be construed in breadth, spirit and scope in accordance with the appended claims.

As mentioned above, while exemplary embodiments have been described in connection with various computing devices and network architectures, the underlying concepts may be applied to any network system and any computing device or system in which it is desirable to publish or consume media in a flexible way.

The word “exemplary” is used herein to mean serving as an example, instance, or illustration. For the avoidance of doubt, this matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, for the avoidance of doubt, such terms are intended to be inclusive in a manner similar to the term “comprising” as an open transition word without precluding any additional or other elements.

Computing devices typically include a variety of media, which can include computer-readable storage media. Computer-readable storage media can be any available storage media that can be accessed by the computer, is typically of a non-transitory nature, and can include both volatile and nonvolatile media, removable and non-removable media. By way of example, and not limitation, computer-readable storage media can be implemented in connection with any method or technology for storage of information such as computer-readable instructions, program modules, structured data, or unstructured data. Computer-readable storage media can include, but are not limited to, RAM, ROM, EEPROM, flash memory or other memory technology, CDROM, digital versatile disk (DVD) or other optical disk storage, magnetic cassettes, magnetic tape, magnetic disk storage or other magnetic storage devices, or other tangible and/or non-transitory media which can be used to store desired information. Computer-readable storage media can be accessed by one or more local or remote computing devices, e.g., via access requests, queries or other data retrieval protocols, for a variety of operations with respect to the information stored by the medium.

As mentioned, the various techniques described herein may be implemented in connection with hardware or software or, where appropriate, with a combination of both. As used herein, the terms “component,” “system” and the like are likewise intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers. Further, a “device” can come in the form of specially designed hardware; generalized hardware made specialized by the execution of software thereon that enables the hardware to perform specific function (e.g., coding and/or decoding); software stored on a computer readable medium; or a combination thereof.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it is to be noted that one or more components may be combined into a single component providing aggregate functionality or divided into several separate sub-components, and that any one or more middle layers, such as a management layer, may be provided to communicatively couple to such sub-components in order to provide integrated functionality. Any components described herein may also interact with one or more other components not specifically described herein but generally known by those of skill in the art.

In view of the exemplary systems described above, methodologies that may be implemented in accordance with the described subject matter will be better appreciated with reference to the flowcharts of the various figures. while for purposes of simplicity of explanation, the methodologies are shown and described as a series of blocks, the claimed subject matter is not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, may be implemented which achieve the same or a similar result. Moreover, not all illustrated blocks may be required to implement the methodologies described hereinafter.

In addition to the various embodiments described herein, it is to be understood that other similar embodiments can be used or modifications and additions can be made to the described embodiment(s) for performing the same or equivalent function of the corresponding embodiment(s) without deviating there from. Still further, multiple processing chips or multiple devices can share the performance of one or more functions described herein, and similarly, storage can be implemented across a plurality of devices. Accordingly, the invention is not to be limited to any single embodiment, but rather can be construed in breadth, spirit and scope in accordance with the appended claims.

What is claimed is:

1. A discharge summary preparation method used for
reading single click input from user
accessing transactions from Physichart server and client databases,
reading data related to treatment and care provided to patient,
reading data related to client billing information related to transactions,
reading data related to treatment orders,
reading data related to post discharge orders,
notifying caregivers of discharge to solicit responses,
incorporating caregiver comments,
compiling discharge summary including all transactions, data, and caregiver comments into a user-definable report format for distribution, and
saving discharge summary to client computer memory.

2. The discharge summary method of claim 1 as part of a system of client component methods operating in multiple client computer systems whereby each method includes saving the discharge summaries into a separate server computer memory.

3. The discharge summary method of claim 1 wherein communication between the components residing in memory at a medical data source, a medical data manager, a server, a client and peripherals is facilitated using internet protocols or hardwiring, and is configured to accommodate existing communication technologies.

4. The discharge summary method of claim 1 further
reading a patient information release and
defining business rules for the scope and limits of disclosure regarding any transactions or information are read from the patient, saved to memory, communicated among all of the computer components, such that information is communicated only when allowed by the patient through release forms according to applicable rules, laws and regulations.

5. The discharge summary method of claim 1 further
updating business rules and medical data on a regular frequency and as needed and
the data for these updates is provided by human managers researching medical data sources.

6. The discharge summary method of claim 1 as part of a system of client component methods that includes a discharge medication component whereby
transferring medication data from the server memory,
including past prescription transaction history,
including current prescription transaction history,
including post-discharge prescription recommendations,
reviewing prescription conflicts,
providing results for caregiver review and soliciting approval,
saving discharge medication component to client memory,
and presenting results as output to the discharge summary component.

7. A system having a computer including a non-transitory memory device that stores an application program and a processor that executes the following computer executable components associated with the application program whereby
a discharge summary preparation component reads a single click input from a user,
the discharge summary component accesses transactions from Physichart server database
the discharge summary component accesses transactions from a client database
the discharge summary component gathers data related to treatment and care provided to patient,
the discharge summary component gathers data related to client billing information related to transactions,
the discharge summary component gathers data related to treatment orders,
the discharge summary component gathers data related to post discharge orders,
the discharge summary component notifies caregivers of discharge to solicit responses,
the discharge summary component incorporates caregiver comments,
the discharge summary component compiles a discharge summary including all transactions, data, caregiver comments into a report format for distribution, and
the discharge summary component saves a discharge summary to client computer memory.

9. The discharge summary component of claim 1 as part of a system including a discharge medication component whereby
a discharge medication component transfers medication data from a Physichart server computer memory,
the discharge medication component includes past prescription transaction history,
the discharge medication component includes current prescription transaction history,
the discharge medication component includes post-discharge prescription recommendations,
the discharge medication component reviews prescription conflicts,
the discharge medication component provides results for caregiver review and solicits approval,
the discharge medication component saves discharge medication component to client memory, and
the discharge medication component presents results as output to the discharge summary component.
